(19) United States
(12) Patent Application Publication
(10) Pub. No.: US 2015/0353409 A1
(43) Pub. Date: Dec. 10, 2015

(54) MEHOD FOR MAKING A SEAMLESS GLASS VESSL USING RESIN BONDED SAND

(71) Applicant: Jay Markel, Boulder, CO (US)

(72) Inventor: Jay Markel, Boulder, CO (US)

(21) Appl. No.: 14/735,380

(22) Filed: Jun. 10, 2015

Related U.S. Application Data
(60) Provisional application No. 62/010,435, filed on Jun. 10, 2014.

(51) Int. Cl. C03B 19/02

(52) U.S. Cl. CPC C03B 19/02

(57) ABSTRACT

A method for manufacturing seamless glass bottles, glass bottles having sculptural designs and shapes, art glass and sculpture in industrial quantities using a mold of resin bonded sand to produce sculptural interior forms having texture, a complex shape with undercuts creating extremely fine surface detail capabilities not otherwise feasible with glass bottle manufacturing.

### CLAIM OF PRIORITY

This patent application claims priority under 35 USC 119 (e) (1) from U.S. Provisional Patent Application Ser. No. 62/010,435 filed Jun. 10, 2014, of common inventorship herewith entitled, “METHOD FOR MAKING A SEAMLESS GLASS VESSEL USING RESIN BONDED SAND,” which is incorporated herein by reference as though the same were set forth in its entirety.

### FIELD OF THE INVENTION

The present invention pertains to the field of glass vessel making, and more specifically to the field of making a seamless glass vessel, including art glass, using resin bonded sand.

### BACKGROUND OF THE INVENTION

The prior art has put forth several designs for making glass vessels. Among these are:

U.S. Pat. No. 1,554,464 to John Rau describes a process for molding a glass bottle consisting of blowing a blank having a neck with a head thereon of the usual character, and forming at the opposite end of said blank an enlarged portion extending laterally beyond the wall of the blank.

U.S. Pat. No. 4,013,437 to John D. Northrup describes a method for forming glass bottles wherein a parison mold having a one-piece annular blank mold section and split neck and should mold sections is charged fully with molten glass. Air is subsequently blown through a manifold covering the upper end of the parison mold to force the molten glass into an annular space defined by a cavity in the neck mold section and a neck pin projected into the neck mold cavity. The neck pin is then reciprocated from the neck mold cavity, and air is blown through the molded neck to cause the molten glass to chill its surface by pressure contact with the inside of an upright truncated pyramidal shaped cavity formed in the blank mold section.

U.S. Pat. No. 4,336,050 to John DI Northrup describes a method for manufacturing glass bottles comprising introducing a gob of molten glass into a blank mold, moving a cavity plunger to form a parison cavity and subsequently subjecting the gob to a predetermined pressure separate from the cavity plunger to apply pressure urging the molten glass into conformity with the mold.

None of these references describe the present invention, which is a method for making a glass vessel using resin bonded sand to form the mold.

### SUMMARY OF THE INVENTION

It is an object of the present invention to provide a method for making a seamless glass vessel, scientific glass vessel or art glass using resin bonded sand.

It is a further object of the present invention to provide a method for making a seamless glass vessel, scientific glass vessel or art glass using resin bonded sand to create an interior form that is different from the exterior form.

It is a further object of the present invention to provide a method for making a seamless glass, or scientific glass vessel or art glass using resin bonded sand with a form, wherein the form can be reused many times.

It is a further object of the present invention to provide a method for making a seamless glass vessel, scientific glass or art glass using resin bonded sand wherein the sand is reusable.

It is a further object of the present invention to provide a method that yields a seamless bottle with either monolithic or pieced molds.

It is a further object of the present invention to provide a method for making a seamless glass vessel, scientific glass vessel or art glass using resin bonded sand in conjunction with an IS machine.

It is a further object of the present invention to provide a method for making a seamless glass vessel, scientific glass vessel or art glass using resin bonded sand in conjunction with mechanically pressing the glass into the mold.

It is a further object of the present invention to provide a method for making a seamless glass vessel, scientific glass vessel or art glass using resin bonded sand in conjunction with press and blow techniques.

It is a further object of this present invention to provide a method for making a seamless glass vessel in which the interior is sculpted into shapes and configurations that are impossible to achieve with most prior art manufacturing methods.

### BRIEF DESCRIPTION OF THE DRAWINGS

FIG. 1 is an illustrative depiction of the components utilized in the method of the present invention.

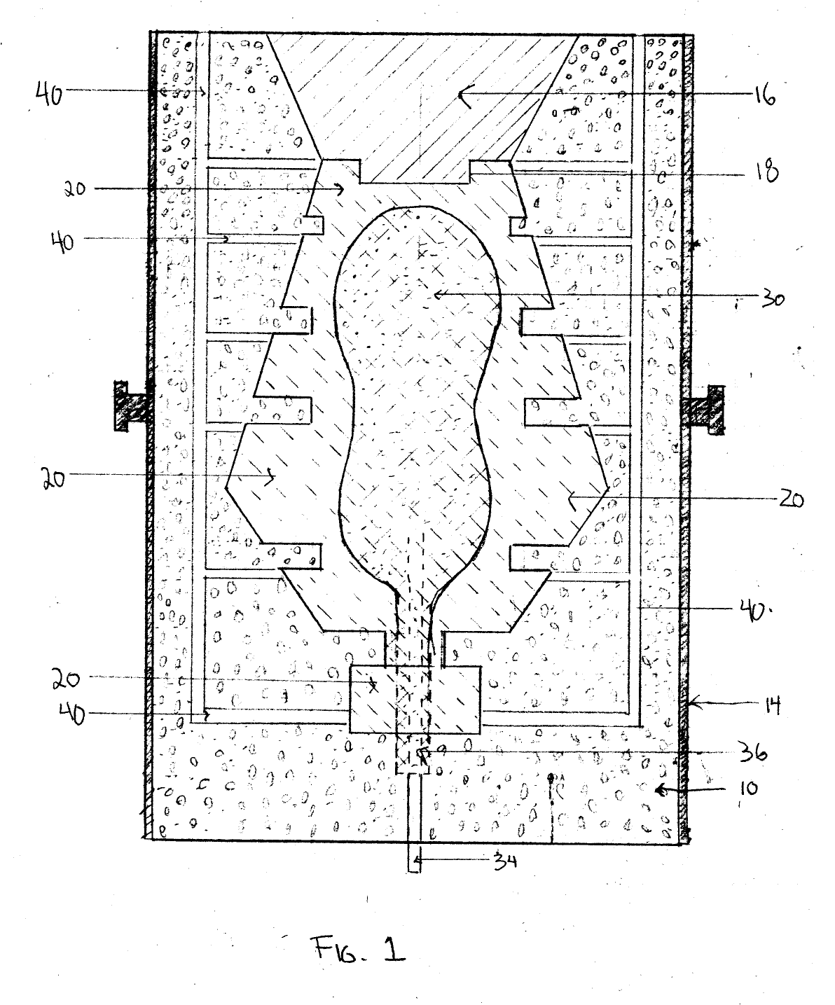

### DETAILED DESCRIPTION OF THE INVENTION

The present invention sets forth a method for manufacturing seamless glass bottles, glass bottles having sculptural designs and shapes, art glass and sculpture in industrial quantities using resin bonded sand. The method presented is for the use of resin bonded sand for glass bottle, glass sculptural forms, vases, objects of art, or scientific glass and scientific glass vessels to be made in industrial quantities, and of a high quality finish.

A unique aspect of this method is the ability to create a complex sculptural form for glass objects created with this method. The objects produced thereby include, but are not limited to, complex sculptural forms to be used for luxury perfume or spirits bottles, high end objects of art, vases, bowls, and complex scientific glass, for example. The method offers industrial scalability, and can be adapted to existing industrial equipment. Whether existing manufacturing lines are adapted, or new industrial production lines are created, the advantage gained is that large quantities of complex forms can be made in a cost effective manner.

It is a further advantage of this method that the forms that can be created by this molding method are distinctly different from the objects created with traditional steel molds used for glass bottle production, utilizing conventional blow and blow, or press and blow methodologies. With this invention, there is no requirement that the interior mold be draftable.

An additional advantage of this method is the ability to achieve a high degree of surface detail with no additional finishing required. As an example, one could create a cut glass look without the time and expense of cutting, and polishing the glass.

As used herein, the term “vessel” and “bottle” are equivalent.

### Description of the Preferred Embodiment

The resin bonded sand is packed through the means of an industrially available sand ramming machine designed for this purpose. It is traditionally done into a steel flask. This flask may be utilized during the handling, glass insertion, and forming stages, and may be removed before an annealing stage. This technique is familiar to anyone conversant with the foundry use of resin bonded sand.

In order to utilize resin bonded sand in the method being disclosed for the production of glass objects, it is essential to properly treat the surface with a high temperature surface treatment. This surfacing treatment is commonly referred to as core wash. Industrially available materials such as zircon core wash, carbon blacking, or other industrial resin sand surface treatments that are capable of sustaining the high temperatures of glass casting are suitable.

Examples of resins suitable for coating include, but are not limited to: PEP SET™X I 1000 Phenolic Resin, and PEP SET™ XII 2000, Polyisocyanate Resin available from Ashland Specialty Chemicals, Covington, Ky. (www.Ashland.com); Alphaset™ phenolic urethane no bake, or cold box resin available from Opta Minerals, Inc., 407 Parkside Drive, Watertown, Ontario L0R 2H0, Canada (www.optaminerals.com). An example of a zircon wash is zirconium dioxide available from www.nyacol.com.

The industrially available wet form core washes such as a zircon core wash, carbon blacking, or other suitable high temperature core wash, will be sprayed into the sand mold to raise the temperature resistance of the resin bonded sand. This is then dried before the glass is inserted into the mold. In one embodiment, a wet form of a zircon core wash will be sprayed onto the surface of the sand mold to raise the temperature resistance of the resin bonded sand and prevent “burn in” of the glass into the sand mold. The mold is then dried before the glass is inserted. The first necessity of this method is to properly treat the surface of the resin bonded sand mold with a high temperature surface treatment such as zircon core wash, or other industrial resin sand surface treatment capable of sustaining the glass molding temperature. A zircon core wash is highly suitable for this purpose. Since the temperature of annealing is sufficient to burn off the resin contained in the sand, if the mold travels through the annealing arch with the object, then the clean sand can be returned to the hopper for reuse. Or, the object can be removed from the mold at such time as the glass is firm enough.

An additional feature of this method is that by utilizing advanced sand molding, this method can replace the much more costly traditional method used to create complex glass forms, such as the lost wax technique.

A separating or parting agent is utilized to prevent the resin impregnated sand from sticking to the form being molded. A dry form of the zircon, or other high temperature foundry material in a powder form will both act as a separating agent, and increase the surface resistance to the glass.

Please refer to the FIGURE to more fully understand the specific methods described below.

### Method 1

If it is deemed desirable to utilize an existing IS Machine for bottle production, the core 30 is suspended into mold 10, wherein the mold is comprised of resin bonded sand and the mold 10 can be put into position in the steel flask 14, and the process proceeds as it would traditionally. Traditionally, the hot gob of molten glass is dropped into the bottom of the mold 10 through gob entry opening 18. A suitable material for closure of a mold having an air attachment covers the gob entry opening 18, and air pressure is applied to press the molten glass against the surfaces of the remote portions of the mold creating the bottle In this traditional system, the bottle neck is initially in an inverted position. A final blow completes the interior space. This is familiar to anyone trained in the art of industrial glass bottle making.

When using a resin bonded sand core, the sand is surface treated with a suitable high temperature core wash. A resin bonded sand core 30 can be used for the creation of a bottle interior that would not be attainable through traditional glass production, i.e., blowing means. This is an important and unique artistic industrial innovation of this method. Core 30 creates a complex, or non blowable interior space. In this instance wherein a resin bonded sand core is used in addition to the resin bonded sand mold, the IS machine is used only to fill the mold and push the glass against the outside walls of the mold, NOT to create the interior of the vessel.

In this method, the core 30 can be secured within the opening of the neck of the bottle. The use of a steel, stainless steel, or other suitable high temperature pin 36, within the resin bonded sand mold 10 will assure its ability to remain in a stable position as the glass is blown, or pressed around the interior sand core by means of a press 16. By these means, sculptural interior forms having textures and complex shapes with undercuts, are achievable. This method offers the possibility for creating extremely fine surface detail capabilities not otherwise feasible with glass bottles, including without limitation, non draftable forms, (i.e., forms that have undercuts making the molded bottle difficult to remove from the mold), thin protrusions from the surface of the bottle, and overlapping surfaces like folds of cloth, or waves, and a great assortment of forms that in the past would have necessitated a lost wax, and investment process. The elimination of the need for using a lost wax process creates finished product directly from the mold.

By this method the bottle can be seamless, and have a traditional top, or neck. It is not necessary to have one end of the mold left open, or weld two glass halves together. Two possible methods for the positioning of this sculptural core are presented.

The sand core 30 can be mechanically positioned into the mold 10 through an open bottom of the mold, and then secured by means of commercially available high temperature core adhesive.

Alternatively, the sand mold can be used without the sand core, wherein the interior cavity is formed by air pressure as in conventional manufacturing processes.

### Method 2

Rather than using an IS machine blow to fill the mold cavity 20 with glass, alternatively, a moveable piece 16 can be utilized to close the mold. This moveable piece can be made of resin bonded sand, steel, or other suitable high temperature material. In this case, the piece 16 is used to press the glass into the mold assuring the complete fill of the mold. This final piece of the mold can also give a sculptural detail to the bottom of the bottle or form being created. This piece is easily automated by means of a suitable mechanical attachment.

The potential advantage of this method is to achieve a more delicate bottom, or even a detail like legs to the bottom of the bottle. In both instances, it is desirable to vent air from the mold. A core vent 34 (or vacuum) may be used for a conventional blow. The porous nature of the resin bonded sand, and the venting into the main mold body and into the sand assists the complete filling of the mold with glass. Vent system 40 facilitates venting. Vent system 40 comprises a system of conduits leading from the inside of the mold to the outside of the mold to allow air to exit the mold. Alternatively, venting is achieved by penetration of interstices of sand in the mold. The porous nature of sand is a result of the interstices between the individual grains of sand allowing movement of gas therethrough. Any suitable sand such as silica sand is useful for making the mold of the present invention, according to the desires of the user. More coarse sand will render a more porous mold, whereas a finer sand will be less porous, require more venting, but will also allow for finer surface detail of the finished vessel. Silica sand of 180 mesh is suitable.

In this way, this method obtains even more complex forms that are industrially scalable, and allows for the creation of objects that previously would have been possible only through a costly lost wax process. The artisanal methods utilized throughout the history of glass making for such objects currently lack a large scale industrial production method.

To assure that the mold is fully filled, the air is vented into the porous core, and also out through the bottom, or other areas of the mold. In the instance of a bottle, the neck might be inverted at the bottom of the mold. The object created from this method is a three dimensional hollow of a pressed glass bottle, or object. The advantage created by this method is that a complete form with a hollow interior can be created. In this way it is vastly different from just a pressed glass bowl, ash tray, or other open object. Therefore, using this method to create a bottle, or other closed form, there is no need for the welding of two halves, nor the need to have an open end to accommodate a retractable press form.

Venting can be done at the optimal positions for air, and excess glass, as is common in glass bottle making. Some of the air within the mold can also be absorbed into the resin bonded sand core and the main body of the resin bonded sand mold.

A multitude of glass insertion methods, air, and vacuum pressure can be utilized with these molds in creative and innovative new ways. The method of utilizing the methods of the present invention can be expanded due to the inherent versatility of the materials.

Venting can be done at either end for air, and excess glass, as is common in glass bottle making. The air release must be calibrated for the specific mold, because a resin bonded sand mold is capable of absorbing air, whereas a conventional steel mold is not.

An additional feature of the method of the present invention is the use of a resin bonded sand core which can offer an interior shape different from the exterior form. This can be held through the neck of the bottle by means of an internal metal armature. This metal armature strengthens the sand core at the thin neck, it also allows for automated handling. In this embodiment, a two piece mold of either resin bonded sand or steel holds the core, and the gob is dropped through the bottom. The mold piece that covers the hole applies mechanical pressure, and has venting capability for air, and excess glass. The resin used for such a sand core must be selected to withstand the temperature of the molten gob as the surface is being formed but which also is susceptible of being burned off in the annealing process, so that the remaining clean sand may be removed and reused. In this case, the sand can simply be poured out of the mold. Any suitable resin may be utilized for this purpose.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A method of making a seamless glass vessel or art glass object comprising: defining the exterior shape of the vessel or object by creating a mold comprising resin bonded sand; defining a hollow cavity within the mold to receive molten glass; inserting a core into the cavity to define the interior volume of the vessel or object wherein the mold has a hollow cavity, inserting a gob of molten glass into the mold and, causing the glass to fill the cavity of the mold except in the space occupied by the core; allowing the glass to solidify; and separating the mold and core from the vessel or object

2. The method of claim 1 wherein the core comprises resin bonded sand.

3. The method of claim 1, wherein the interior surface of the mold is treated with a coating to improve the heat resistance of the resin prior to solidification of the glass.

4. The method of claim 1, wherein the vessel or object has a complex exterior surface and a complex interior surface, wherein the exterior surface has a different shape than the interior surface.

5. The method of claim 3 wherein the high temperature surface treatment is a zircon core wash or carbon blacking.

6. The method of claim 1, wherein gas pressure is used to facilitate the flow of molten glass into remote portions of the mold.

7. The method of claim 1, wherein mechanical pressure is used to facilitate the flow of molten glass into remote portions of the mold.

8. The method of claim 3 wherein venting is achieved by a venting system of conduits leading from the vessel to outside the mold.

9. The method of claim 3 wherein venting is achieved by allowing the flow of gas through interstices in the sand used for the mold.

10. A method of making a seamless glass vessel or art object glass comprising: using a mold comprising resin bonded sand for defining the exterior surface of the vessel or object, the mold first having been packed into a metal flask; the mold having an interior cavity for receiving molten glass; the mold containing a core within the cavity for defining an interior volume within the vessel or object; the core stabilized inside the cavity; the resin bonded sand mold having been treated with a high temperature surface treatment; inserting a gob of molten glass into the mold; causing the glass to fill substantially all portions of the cavity of the mold except for the volume occupied by the core; venting the interior of the mold to allow air to escape; allowing the vessel or object to solidity; and annealing the vessel or object to allow removal of the resin bonded sand.

11. The method of claim 10, wherein stabilization is achieved by means of a pin.

12. The method of claim 10, wherein stabilization is achieved by means of a high temperature adhesive.

13. A method of making a seamless glass vessel or art glass object comprising: defining the exterior shape of the vessel or object by creating a mold comprising resin bonded sand; defining a hollow cavity within the mold to receive molten glass; inserting a gob of molten glass into the mold and causing the glass to fill the remote portions of the mold; using air pressure to create a hollow space within the molten glass to define the interior of the vessel or object; allowing the glass to solidify; and separating the mold from the vessel or object.
